(19) United States
(12) Patent Application Publication
(10) Pub. No.: US 2007/0013958 A1
(43) Pub. Date: Jan. 18, 2007

(54) SCAN SYSTEM WITH MULTI-LIGHT SOURCES AND SCANNING METHOD THEREOF

(75) Inventor: Yong-Xiang Yi, Jiangsu Province (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/456,239

(22) Filed: Jul. 10, 2006

(30) Foreign Application Priority Data
Jul. 12, 2005 (TW) 94123653

(51) Int. Cl. H04N 1/23

(52) U.S. Cl. 358/302; 362/249; 362/270

(57) ABSTRACT

A scan system and a scanning method are provided, The scan system is for scanning a transparent document. The scan system includes a backlight module, an optical module and a control unit. The backlight module has several light sources. The transparent document is disposed between the backlight module and the optical module. The optical module is capable of moving with respect to the transparent document and the backlight module for capturing the image of the transparent document. The control unit controls the backlight module to turn on at least parts of the light sources. When the optical module moves with respect to the transparent document to several positions at different time points, parts of the light sources corresponding to the positions are sequentially turned on. The light emitted by the light sources is projected into the optical module after passing through the transparent document.

This application claims the benefit of Taiwan application Serial No 94123653, filed on Jul. 12, 2005, the subject matter of which is incorporated herein by reference.

### BACKGROUND OF THE INVENTION

1. Field of the Invention

The invention relates in general to a scan system and a scanning method thereof, and more particularly to a scan system with multi-light sources and a scanning method thereof.

2. Description of the Related Art

Currently, the scanning of transparent document (positive film and negative film) is categorized according to whether the light source is movable or fixed. The two types of scanning are disclosed and their respective advantages and disadvantages are discussed below.

Referring to FIG. 1A, a diagram of a conventional scanning device whose light source is fixed is shown. The scanning device 100a whose light source is fixed is used for scanning a transparent document 107. The scanning device 100a whose light source is fixed includes a light source 101, a light guide plate 102 and an optical module 103. The optical module 103 moves along with a step motor to receive and convert a photo signal into an electrical signal. The light source 101 is fixed on the light guide plate 102. The light generated by the light source 101 is diffused into uniformed and parallel light by the light guide plate 102 and projected accordingly. The light source 101 and the light guide plate 102 do not move along with the step motor,

Referring to FIG. 1B, a diagram of a conventional scanning device whose light source is movable is shown. Unlike the light source of the scanning device 100a, the light source of the scanning device 100b is movable for enabling the light source 101 and the optical module 103 to move simultaneously. As shown in FIG. 1B, the optical module 103 and the light source 101 move towards the x direction simultaneously.

In terms of the scanning device 100a whose light source is fixed, despite the light is emitted via the light guide plate 102 is uniformed and parallel, the brightness of the light is weakened. In order to compensate the brightness of the light, the inputted voltage for driving the light source 101 needs to be increased.

In terms of the scanning device 100b whose light source is movable, the light source 101 and the optical module 102 move simultaneously, but a higher precision of mechanic control is required, leading to an increase in manufacturing cost. Moreover, the size of the optical module 103 is normally larger, hence becoming less practical.

### SUMMARY OF THE INVENTION

It is therefore an object of the invention to provide a scan system with multi-light sources capable of providing uniformed brightness and high illuminating efficiency and a scanning method thereof.

The invention achieves the above-identified object by providing scan system with multi-light sources. The scan system is used for scanning a transparent document. The scan system includes a backlight module, an optical module and a control unit. The backlight module has several light sources spread over the backlight module. The transparent document is disposed between the backlight module and the optical module. The optical module is capable of moving with respect to the transparent document and the backlight module for capturing the image of the transparent document. The control unit is used for controlling the movement of the optical module and correspondingly controlling the backlight module to turn on at least parts of the light sources. When the optical module moves with respect to the transparent document to several positions at different time points, parts of the light sources corresponding to the positions are sequentially turned on. The light emitted by the light sources is projected into the optical module after passing through the transparent document.

The invention further achieves the above-identified object by providing a scanning method of transparent document. The transparent document is placed in the scan system The scan system includes a backlight module, an optical module and a control unit. The backlight module has several light sources, The control unit is used for controlling the optical module and the backlight module for enabling the optical module to receive parts of the light generated by the light sources. The scanning method includes the following steps. Firstly, the optical module is driven for enabling the optical module to move along one side of the transparent document Then, the movement of the optical module is calculated and a control signal is sent by the control unit. Next, the control signal is received by the backlight module. Lastly, parts of the light sources are turned on according to the control signal.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a diagram of a conventional scanning device whose light source is fixed;

FIG. 1B (PriorArt) is a diagram of a conventional scanning device whose light source is movable;

FIG. 2 is a 3-D diagram of a scan system with multi-light sources according to the first embodiment of the invention,

FIG. 3 is a 3-D diagram of a backlight module;

FIG. 4 is a distribution diagram of the brightness of light sources;

FIG. 5 is a flowchart showing the scanning method of the transparent document; and

FIG. 6 is a 3-D diagram of the scan system with multi-light sources according to the second embodiment of the invention.

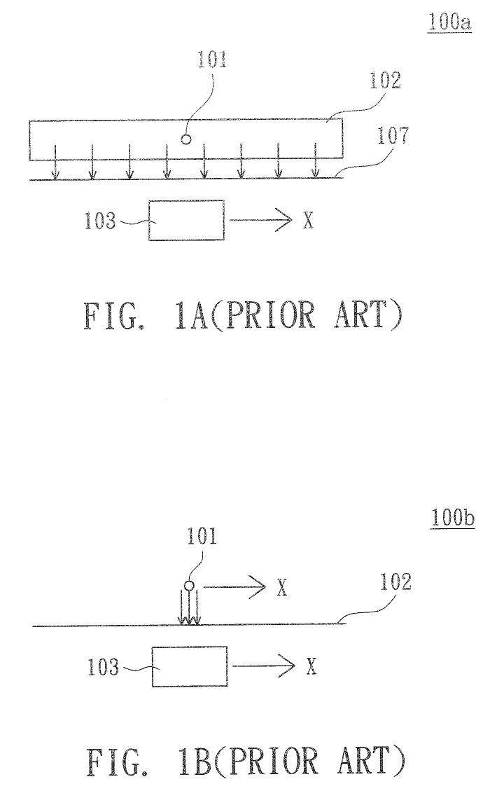

### DETAILED DESCRIPTION OF THE INVENTION

### First Embodiment

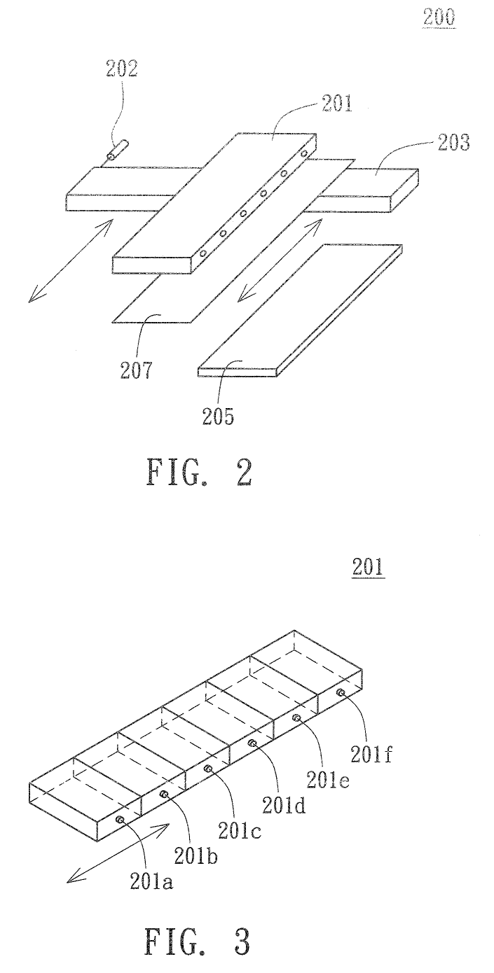

Referring to both FIG. 2 and FIG. 3. FIG. 2 is a 3-D diagram of a scan system with multi-light sources according to the first embodiment of the invention. The scan system with multi-light sources 200 includes a backlight module 201, an optical module 203, a control unit 205 and a step motor 202. The backlight module 201 and the optical module 203 are respectively disposed on the two sides of the transparent document 207. That is, the backlight module 201 is fixedly disposed on the top surface of the transparent document 207, while the optical module 203 is removably disposed on the bottom surface of the transparent document 207. The control unit 205, such as a printed circuit board (PCB) for instance, is fixed on the scan system with multi-light sources 200 The optical module 203 includes a photo-electrically charge coupled device (CCD) optical module or a complementary metal oxide semiconductor (CMOS) optical module.

Referring to FIG. 3, a 3-D diagram of a backlight module is shown. The backlight module is equipped with several light sources, light guide plates or reflective plates. The light source 201 including light source 201a to light source 201f can be light emitting diodes (LEDs), discharge lamps or other forms of light sources. Preferably, the light source 201 is an LED light source, while the diffusion components such as the light guide plate and the reflective plate are used for guiding the light to be uniformly projected into the backlight module 201.

The movement of the optical module 203 is driven by the step motor 202. By correctly calculating the lit-up time and correspondingly controlling the rotation speed or step number of the step motor 202, the light sources are turned on in turn, increasing the efficiency of illumination of and the uniformity of brightness of the scan system with multi-light sources 200. The distance of the movement of the optical module 203 is positively correlated with the steps of the step motor 202. The step numbers of the step motor 202 are determined by the number of pulses of a control signal controlling the step motor 202. The rotation speed of the step motor 202 can be adjusted by adjusting the number of pulses within a time unit. The theory and control method of scanning applied in the scan system with multi-light sources are disclosed below.

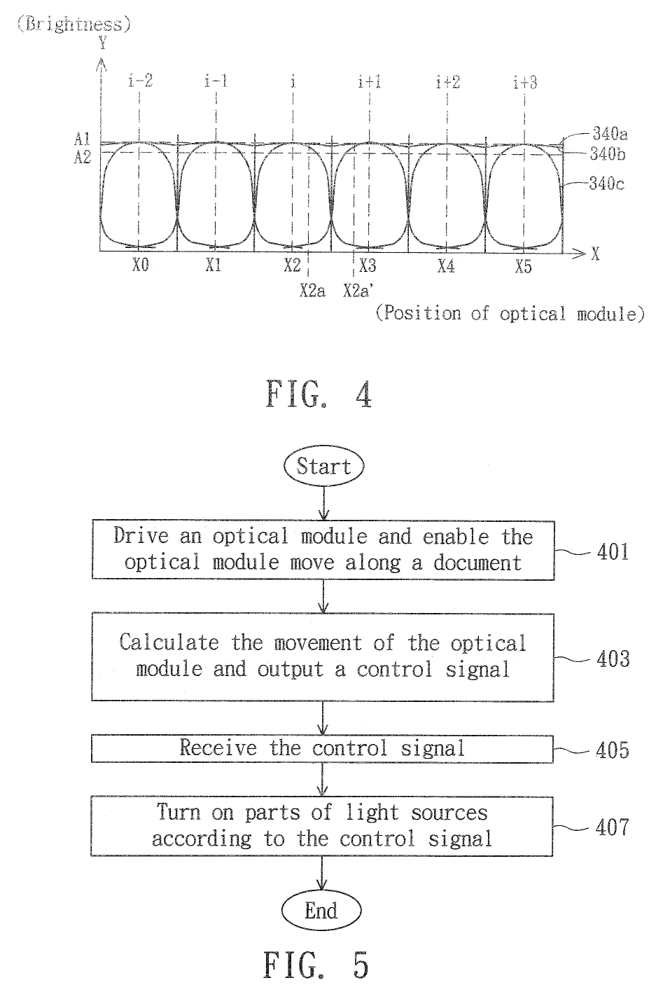

Referring to both FIG. 3 and FIG. 4 FIG. 4 is a distribution diagram of the brightness of light sources. In FIG, 4, the horizontal axis (x-axis) denotes the position of the optical module, while the vertical axis (y-axis) denotes the level of brightness. When driven by the step motor 202, the optical module 203 moves along the horizontal axis (x-axis). In FIG. 4, the straight line 340a denotes ideal brightness. Ideally, the brightness is maintained constant during the movement of the optical module 203. The actual distribution of brightness is illustrated below.

Referring to the curve 340c, curves illustrating the distribution of brightness of individual light source when the light sources are turned on sequentially are shown. The curve 340c is featured by the segment of the curve. For example, the segment i is convex in the middle but concave in both sides. The physical significance is that the position below the light sources 201a has the highest brightness, and that the farther away from the position below the light sources 201a, the lower the brightness will be consequently, and that the two sides have a non-uniformed distribution of brightness and are darker. Similarly, all the segments from segment i−2 to segment i+2 are the same, thus the continuous curve 340c with non-uniformed distribution of brightness is formed.

In order to resolve the problem of having non-uniformed distribution of brightness, the light sources are turned on sequentially. Referring to the curve 340b the curve 340b is obtained by overlapping the brightness curve of individual light source. That is, the curve 340b denotes the distribution of brightness with the light sources 201a-201f being turned on sequentially.

Suppose the position X2 of the optical module is below the segment i (the light sources 201c) when the optical module moves along the x-axis direction, the value of the corresponding brightness is A1. As the optical module continues to move towards the X direction, the brightness A1 diminishes, and the farther away from the position X2, the lower the brightness will be consequently. When the brightness is getting closer to a pre-determined value, such as A2 brightness for instance, wherein A2 is smaller than A1, the corresponding position of the optical module is X2a, and the light source (the light source 201d) corresponding to the segment i+1 will be turned on. That is, at the position of X2a, the brightness begins to be provided by the light sources 201c and 201d together As the optical module continues to move along the x-axis direction, the brightness increases gradually. As the brightness is increased to be close to the A2 brightness, the optical module corresponds to the position X2a′, and the light source (the light source 201c) corresponding to the segment i will be turned off. That is, at the position of X2a′, the brightness only needs to be provided by the light source 201d corresponding to the segment i+1 for the inadequate brightness to be compensated.

Similarly, whether the light source of a segment is turned on or not can be understood. As for the positions which have been scanned, the light sources of corresponding positions can be turned off without affecting then brightness distribution of the positions which have not been scanned yet. in the present embodiment, the time points of turning on the light sources can be calculated for enabling the brightness curve to approach the ideal curve 340a, which implies the distribution of brightness is near uniformed.

A scanning method is provided in the scan system with multi-light sources of the present embodiment. Referring to FIG. 5 a flowchart showing the scanning method of the transparent document is shown. The scanning method begins at step 401: the optical module 203 is driven to move along one side of the transparent document 207. Then, proceed to step 403: the control unit 205 calculates the relative position between the optical module 203 and the backlight module 201 and sends a control signal accordingly. Next, proceed to step 405: the control signal is received by the backlight module 201. Lastly, proceed to step 407: the backlight module 201 is used to turn on parts of the light sources 201a-201f according to the control signal.

### Second Embodiment

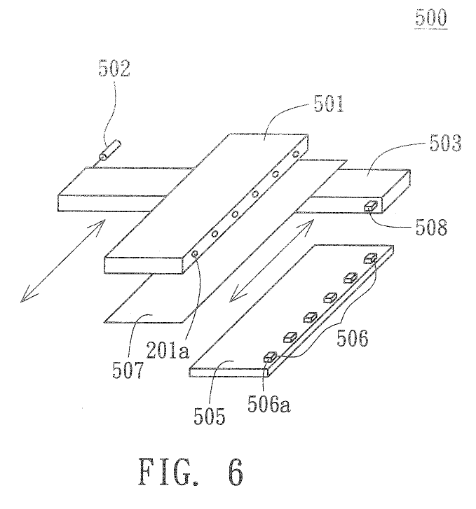

Referring to FIG. 6, a 3-D diagram of the scan system with multi-light sources according to the second embodiment of the invention. Unlike the first embodiment, the control unit 505 of the second embodiment further includes several infra-red receivers 506, while the optical module 503 is equipped with an infra-red transmitter 508. When the optical module 503 performs scanning under the transparent document 507, the receiver 506 positioned on the control unit 505 receives the signal sent by the infra-red transmitter 508. Each infra-red receiver 506 respectively corresponds to each light source of the backlight module 501. For example, the corresponding receiver of the light sources 201a is the infra-red receiver 506a. That the infra-red receiver 506a receives the signal sent by the infra-red transmitter 508 implies that the optical module 503 is adjacent to light sources 201a, and that the control unit 505 will control the light sources 201a to be turned on. Similarly, the time points of turning on the light sources can be calculated more precisely according to the signals transmitted by the infra-red transmitter 508 and the signals received by each infra-red receiver 506, thereby enhancing the quality and uniformity of the light sensed by the optical module 503.

The way to turn on several light sources sequentially not only avoids having a large backlight module size if a movable type light source is adopted, but also avoid having a poor brightness if a fixed type light source is adopted. Hence, the scanning quality of the scan system is enhanced.

Despite the scan system with multi-light sources and the scanning method thereof of the invention are exemplified by the scanning of the transparent document, the scanning method of sequentially turning on several light sources is also applicable to the scanning of the reflective document. The difference is that when applied in the scanning of the reflective document, the backlight module and the optical module are disposed in the same side of the reflective document.

While the invention has been described by way of example and in terms of a preferred embodiment, it is to be understood that the invention is not limited thereto On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scan system for scanning a transparent document, comprising:
a backlight module having a plurality of light sources;
an optical module for moving with respect to the transparent document and the backlight module to capture the image of the transparent document, wherein the transparent document is disposed between the backlight module and the optical module; and
a control unit for controlling the movement of the optical module and correspondingly controlling the backlight module to turn on at least parts of the light sources;
wherein when the optical module moves with respect to the transparent document to a plurality of positions at different time points, parts of the light sources corresponding to the positions are sequentially turned on, the light emitted by the light sources is projected into the optical module after passing through the transparent document.

2. The system according to claim 1, further comprising:
a step motor for driving the optical module to move, wherein the control unit calculates the position of the optical module according to the rotation speed or step number of the step motor to determine whether to turn on the light source corresponding to the current position of the optical module.

3. The system according to claim 1, wherein the control unit comprises a plurality of receivers, the position of each receiver corresponds to that of each light source, the optical module comprises.
a transmitter for outputting a signal to one of the receivers to enable the control unit to obtain the position of the optical module and determine whether to turn on the corresponding parts of the light sources.

4. The system according to claim 3, wherein the transmitter and each receiver respectively are an infra-red transmitter and an infra-red receiver.

5. The system according to claim 1, wherein the backlight module comprises:
a light guide plate for guiding the light generated by parts of the light sources to be uniformly projected out of the backlight module.

6. The system according to claim 1, wherein the optical module is a photo-electrically charge coupled device (COD) optical module or a complementary metal oxide semiconductor (CMOS) optical module.

7. The system according to claim 1, wherein the light sources are uniformly spread over a scanning region, and the optical module captures the image of the transparent document in the scanning region.

8. The system according to claim 1, wherein the light sources are sequentially turned on and one or two of the light sources are turned on at a time, while the remaining light sources are turned off.

9. A scanning method, comprising:
driving an optical module by using a step motor for enabling the optical module move along a document;
calculating the movement of the optical module and outputting a control signal;
receiving the control signal; and
turning on parts of a plurality of light sources according to the control signal for enabling the optical module to receive the light generated by parts of the light sources.

10. The method according to claim 9, further comprising:
turning the remaining light sources according to the control signal.

11. The method according to claim 9, wherein the step of calculating the movement of the optical module further comprises:
calculating the brightness distribution of parts of the light sources to determine whether to send the control signal.

12. The method according to claim 9, wherein the step of calculating the movement of the optical module comprises:
emitting a position signal;
receiving the position signal; and
calculating the movement of the optical module according to the

13. The method according to claim 12, wherein the position signal is an infrared signal.

14. The method according to claim 9, wherein the step of calculating the movement of the optical module comprises:
calculating the rotation speed or step number of the step motor; and
calculating the movement of the optical module according to the rotation speed or step number of the step motor.

15. The method according to claim 9, wherein the light generated by the light sources can be uniformly emitted via a light guide plate.
